(19) United States
(12) Patent Application Publication
(10) Pub. No.: US 2005/0106292 A1
(43) Pub. Date: May 19, 2005

(54) High moisture, shelf-stable acidulated food products

(76) Inventors: Gordon R. Huber, Sabetha, KS (US); Maurice Clarence Kemp, Rocklin, CA (US); Zhong Wei Xie, Folsom, CA (US)

Correspondence Address: HOVEY WILLIAMS LLP, 2405 GRAND BLVD., SUITE 400, KANSAS CITY, MO, 64108, US

(21) Appl. No.: 10/712,178

(22) Filed: Nov. 13, 2003

(51) Int. Cl. C12C 1/027

(52) U.S. Cl. 426/106

(57) ABSTRACT

Shelf-stable food products are provided in the form of at least partially hydrated foods having a water activity of at least about 0.65 and with a sufficient amount of an added acidulent to give the food an acidic pH of up to about 6. The acidulated foods are non-aseptically packaged in a substantially moisture-tight package, so that the resultant food product is capable of ambient temperature storage for at least about 30 days without spoilage of the food. Suitable foods include pastas and other grain or grain-derived products.

### BACKGROUND OF THE INVENTION

1. Field of the Invention

The present invention is broadly concerned with improved shelf-stable fully or partially hydrated and/or cooked foods which can be non-aseptically packaged and stored over extended periods at ambient temperature without spoilage or degradation of the foods and without compromising the taste and other desirable organoleptic properties thereof. More particularly, the invention is concerned with such foods and methods of preparation thereof wherein the foods have a water activity of at least about 0.65 and are supplemented with an added, specialized acidulent to assure that the pH is in the acidic range of up to about 6. Preferred acidulents include sparingly soluble Group IIA acidic complexes, highly acidic metalated organic acids, highly acidic metalated mixtures of inorganic acids, and mixtures of the foregoing.

2. Description of the Prior Art

There is an increasing demand for prepared foods which are either ready to eat or require only a minimum of cooking or heating prior to consumption. Purveyors of these foods must typically refrigerate the foods from production through purchase by a consumer, or alternately make use of special and very expensive packaging techniques such as aseptic packaging. Examples of foods of this type are fully cooked pastas and related grain-based products, which require constant refrigeration. Other foods in the nature of doughs for breads or sweetened baked or fried products (e.g., cookies) also need to be refrigerated.

It is known that addition of significant acid to foods can lengthen shelf life owing to the anti-bacterial effect of acidic pH. However, use of normal acids generally imparts a sharp and unpleasant taste to the foods, and this significantly limits the usefulness of straightforward pH reduction.

U.S. Pat. No. 6,436,891 describes a class of sparingly soluble Group IIA acid complexes which can be applied to raw, uncooked foods in order to reduce bacterial counts without adversely affecting taste or other properties of the foods. Similarly, U.S. Pat. No. 6,572,908 discloses a class of highly acidic metalated organic acids which can be used to decontaminate fruits and prolong the shelf life of sausages. U.S. patent application Publication US2002/0197365 discloses highly acidic metalated inorganic acids which can be applied to meat products to retard microbial growth. However, these references do not deal with preservation of high water activity, non-aseptically packaged foods.

There is accordingly a need in the art for improved, high quality foods having good organoleptic properties and which can be provided in partially or fully hydrated and/or cooked condition for storage under ambient conditions for significant time periods without degradation or spoilage.

### SUMMARY OF THE INVENTION

The present invention overcomes the problems outlined above and provides improved shelf-stable food products and methods of preparation thereof. The foods products of the invention comprise an at least partially hydrated food having a water activity of at least about 0.65 with a sufficient amount of an added acidulent to give the food an acidic pH of up to about 6. Such foods are non-aseptically packaged in substantially moisture-proof packages, and are capable of ambient temperature storage for at least about 30 days without spoilage of the food within the package. The invention is thus admirably suited for the provision of shelf-stable ready to eat foods or dough products traditionally requiring specialized packaging and/or refrigeration.

In preferred forms, the acidulents are selected from sparingly soluble Group IIA acidic complexes, highly acidic metalated organic acids, highly acidic metalated mixtures of inorganic acids, and mixtures of the foregoing, and these can be supplemented with an additive such as lactic acid and a preservative. It has been found that acidulents of this character do not alter conventional processing conditions for the foods or impart any undesirable taste or properties.

### BRIEF DESCRIPTION OF THE DRAWINGS

FIG. 1 is a graph illustrating anaerobic plate counts of modified atmosphere packaged extruded rice with acidulent and potassium sorbate (Example 1, Run #5) as compared with modified atmosphere packaged non-treated control extruded rice, during storage at room temperature, where “CONT” refers to the control rice and “TRT” refers to the treated rice;

FIG. 2 is a graph illustrating yeast counts of modified atmosphere packaged extruded rice with acidulent and potassium sorbate (Example 1, Run #5) as compared with modified atmosphere packaged non-treated control extruded rice, during storage at room temperature, where “CONT” refers to the control rice and “TRT” refers to the treated rice;

FIG. 3 is a graph illustrating mold counts of modified atmosphere packaged extruded rice with acidulent and potassium sorbate (Example 1, Run #5) as compared with modified atmosphere packaged non-treated control extruded rice, during storage at room temperature, where “CONT” refers to the control rice and “TRT” refers to the treated rice;

FIG. 4 is a graph illustrating appearance and visual score of modified atmosphere packaged extruded rice with acidulent and potassium sorbate (Example 1, Run #5) as compared with modified atmosphere packaged non-treated control extruded rice, during storage at room temperature, where “LEAKERS” refers to packages which leaked, “L-MOLD” refers to packages which leaked and exhibited mold growth, “NL-MOLD” refers to non-leaking packages exhibiting mold growth and “GASSY” refers to packages partially inflated with generated gas; and

FIG. 5 is a graph illustrating the bacterial count data obtained with control and acidulent-treated chocolate chip cookie dough under ambient storage conditions, as described in Example 3.

### DETAILED DESCRIPTION OF THE PREFERRED EMBODIMENTS

The present invention is concerned with shelf-stable food products and methods of preparing the same, as well as treated fractions or components of food products. The invention has wide applicability across a wide gamut of foods, especially those containing significant proportions of grain or grain derivatives. Broadly speaking, it has been determined that highly desirable shelf-stable food products heretofore requiring aseptic packaging or continuous refrigeration (typically having a water activity of at least about 0.65, more commonly above about 0.7) can be prepared and conventionally packaged for ambient temperature storage for at least about 30 days without food spoilage; moreover, these products exhibit highly desirable organoleptic properties. Such foods are prepared with one or more specialized acidulents so as to lower the pH of the food to a level of up to about 6, and more preferably from about 1-4.5, but do not have any pronounced acidic taste.

One important class of food product in accordance with the invention are pasta products normally containing a substantial fraction of at least about 35% by weight, and more commonly in excess of 75% by weight of Durum or other wheat flour. These pastas can be prepared in a number of ways to achieve the shelf stability of the invention. Pastas are conventionally extrusion formed and dried to a low moisture level for packaging. The consumer must then fully hydrate and cook the pastas prior to consumption. However, in accordance with the invention, it is possible to provide partially or fully cooked pastas which can be conventionally (i.e., non-aseptically) packaged without modified atmospheres which can then be stored at ambient temperatures for extended periods of at least about 30 days, more preferably at least about 60 days, without spoilage of the pasta products.

For example, it is possible to equip a conventional pasta plant with hot water baths so that the extruded pasta is immediately delivered to a hot water bath (180-212° F.) for partial cooking. Thereafter, the pasta is delivered to a second hot water bath containing an acidulent in accordance with the invention for completion of cooking. Alternately, the pasta could be fully cooked in the initial hot water bath, followed by spraying or dip application of a relatively concentrated acidulent at ambient temperature. Preferably, the acidulated pasta is then treated with a preservative such as an alkali metal sorbate via rinsing, dipping or spraying. The finished pasta products may then be conventionally packaged using flexible film packaging with or without a modified atmosphere to achieve a substantially moisture-tight package. Such cooked pastas in a hydrated condition can be stored under ambient conditions for extended periods. The consumer thus can immediately consume the pasta upon opening of the package, with microwave or other heating if desired.

Cooked pastas in accordance with the invention can also be prepared using an extrusion cooker. Such a technique is broadly disclosed in U.S. Pat. No. 5,059,439 incorporated by reference herein. However, in the preparation of pastas using an extrusion cooker, the acidulent and preservative (if used) is added to the preconditioner or extruder barrel as convenient. It has been found that introduction of the preservative and acidulent in serial order in the preconditioner is an effective way of producing desirable extrusion cooked pastas.

Other grain products such as rice, couscous, polentas and masas are suitable for treatment with acidulents in accordance with the invention. Most advantageously, grain flours are extrusion processed with introduction of acidulent and preservative, as described above. However, as in the case of the pastas, these grain-derived products may be conventionally hydrated and cooked (either partially or wholly), followed by application of acidulent and preservative by any suitable means. Here again, these final grain-type products in partially or fully hydrolyzed and partially or fully cooked condition can be readily packaged for long-term ambient temperature storage without spoilage or significant degradation of the foods. In the case of rice, rice flour may be extruded using the technology described in U.S. Pat. No. 4,769,251 (incorporated by reference herein) with addition of acidulent and preservative to produce the desired shelf-stable products.

Modified dough products can also be formulated for ambient temperature shelf stability. Thus, cookie doughs containing substantial wheat flour, shortening, sugar, eggs and flavorings can be first prepared in the usual fashion, followed by addition of acidulent and preservative. Such addition can be achieved by direct mixing of the acidulent and preservative into the dough, or by spraying and dipping. In another aspect of the invention, such doughs can be formulated using, as a part of the overall wheat flour fraction thereof, individual, pretreated acidulent and preservative wheat flour fractions. Specifically, these pretreated fractions are preferably prepared by extrusion, i.e., wheat flour is extrusion processed with the introduction of acidulent or preservative, so that these ingredients are effectively encapsulated within the wheat protein/starch matrix.

More broadly, essentially any extrudable substrate capable of forming a matrix can be used for encapsulation of the acidulent and preservative. The substrates would most commonly be selected from the group consisting of grains (e.g., wheat, oats, barley, corn, milo, rice, rye and mixtures thereof) and starches (grain, root and tuber starches such as rice, wheat, oats, barley, corn, potato and rye).

The invention also finds applicability in connection with other types of hydrated and/or cooked foods. These would include vegetables and fruits which may be blanched or cooked followed by application of acidulent and preservative by spraying or dipping; comminuted meat products such as ground meats; and cheese or other dairy products.

The amounts of acidulent and preservative used in the invention can vary widely, depending upon the type of product in question. Generally speaking though, the acidulent is normally present at a level of from about 0.1-7% by weight, more preferably from about 0.1-2% by weight, based upon the total weight of the at least partially hydrated food taken as 100% by weight. Similarly, the preservative is normally present at a level of from about 0.1-0.5% by weight, more preferably from about 0.1-0.2% by weight, based upon the total weight of the at least partially hydrated food taken as 100% by weight.

A variety of acidulents can be used in the context of the invention, either alone or in various combinations. One such class of acids are sparingly-soluble Group IIA complexes (“AGIIS”) of the type described in U.S. Pat. No. 6,436,891, incorporated by reference herein. Such complexes are of low volatility and corrosivity at room temperatures.

One preferred type of AGIIS complexes are the acidulated calcium sulfates (“ACS”), which are believed to be near-saturated, saturated, or super-saturated calcium, sulfate anions or variations thereof, and/or complex ions containing calcium, sulfates, and/or variations thereof.

The term “complex,” as used herein, denotes a composition wherein individual constituents are associated. “Associated” means constituents are bound to one another either covalently or non-covalently, the latter as a result of hydrogen bonding or other inter-molecular forces. The constituents may be present in ionic, non-ionic, hydrated or other forms.

The acidic solution of sparingly-soluble Group IIA-complex salt can be prepared in several ways. Some of the methods involve the use of Group IA hydroxide but some of syntheses are devoid of the use of any added Group IA hydroxide, although it is possible that a small amount of Group IA metal may be present as “impurities.” The preferred way of manufacturing AGIIS is not to add Group IA hydroxide to the mixture. As the phrase implies, AGIIS is highly acidic, ionic, with a pH of below about 2.

Wurzburger, et al. in U.S. Pat. No. 5,830,838 describes an acidic solution prepared by the “calcium-hydroxide/potassium-hydroxide method.” The solution is produced by first adding two moles of concentrated sulfuric acid (93%) to 2 liters of de-ionized water. Separately, an aqueous solution of base is prepared by adding one mole of calcium hydroxide (hydrated lime) and two moles of potassium hydroxide to 20 liters of de-ionized water with stirring. The acid solution is then mixed with the base solution. The mixture is then filtered through a 10 micron filter to remove particles of calcium sulfate or potassium sulfate of eleven microns or larger. The resulting concentrate can be used full strength or diluted with water depending on the metal surfaces to be treated. Sodium hydroxide may be used in place of potassium hydroxide. Hydrated calcium oxide may be used in place of calcium hydroxide. Another source of the base is calcium metal. In either case and as one embodiment of this application, the resultant solution is a highly acidic solution. This highly acidic solution can be diluted with water to adjust its pH to a desired higher value, i.e. less acidic.

Another way of preparing the acidic solution is by the “calcium-metal method” which involves reacting concentrated sulfuric acid with calcium metal followed by filtration. One mole of concentrated sulfuric acid was diluted with 40 moles of de-ionized water. Then, one mole of calcium metal turnings was slowly added with stirring into the solution of sulfuric acid. The stirring was continued until essentially all metal had dissolved. The resultant mixture was allowed to settle for about 5 to 6 hours before the supernatant was filtered through a 10 micron filter. The concentrate thus obtained had a pH value of about 0.5. This concentrate of hydronium ions was then diluted with de-ionized water to the desired pH value, such as pH of about 1 or about 1.8.

Then, there is the “calcium-hydride method” which involves reacting concentrated sulfuric acid and calcium hydride in water. One mole of concentrated sulfuric acid was diluted with 40 moles of de-ionized water. With agitation, 1 mole of calcium hydride was slowly added to the solution of sulfuric acid. The agitation was continued until the calcium hydride has essentially all dissolved. After the dissolution, the mixture was then allowed to settle for about 5 to 6 hours, at that time the supernatant was filtered through a 10 micron filter. The concentrate thus obtained had a pH value of about 0.1 to about 0.2, and can be further diluted.

One product from the “calcium-metal method” or “calcium-hydride method” having a pH of from −0.2 to −0.3, and from 1.4 to 1.5 acid normality gave the following analyses: Ca, 763 ppm; SO₄, 84633 ppm; Na, 4.76 ppm; K, 3.33 ppm; and Mg, 35.7 ppm.

The “calcium-metal method” and the “calcium-hydride method” have certain drawbacks. In each of these methods, thermal control is very difficult to achieve because of the large amount of heat generated when concentrated sulfuric acid is reacted with either calcium metal or calcium hydride. The difficulties in thermal control of the reactions cause the reactions to be difficult to reproduce and hard to control.

The preferred method of preparing AGIIS involves mixing a mineral acid with a Group IIA hydroxide, or with a Group IIA salt of a dibasic acid, or with a mixture of the two Group IIA materials. In the mixing, a salt of Group IIA is also formed. Preferably, the starting Group IIA material or materials selected will give rise to, and form, the Group IIA salt or salts that are sparingly soluble in water. The preferred mineral acid is sulfuric acid, the preferred Group IIA hydroxide is calcium hydroxide, and the prefer Group IIA salt of a dibasic acid is calcium sulfate. Other examples of Group IIA salt include calcium oxide, calcium carbonate, and “calcium bicarbonate.”

Thus, for example, AGIIS can be prepared by mixing or blending starting materials given in one of the following scheme with good reproducibility:
(1) H₂SO₄ and Ca(OH)₂;
(2) H₂SO₄, Ca(OH)₂, and CaCO₃;
(3) H₂SO₄, Ca(OH)₂, CaCO₃, and CO₂ (gas);
(4) H₂SO₄ and CaCO₃;
(5) H₂O₄, CaCO₃, and Ca(OH)₂;
(6) H₂SO₄, CaCO₃, and CO₂ (gas);
(7) H₂SO₄ and CaSO₄;
(8) H₂SO₄, Ca(OH)₂, and CaSO₄;
(9) H₂SO₄, CaSO₄, and CaCO₄;
(10) H₂SO₄, CaSO₄, CaCO₃, and Ca(OH)₂
(11) H₂SO₄, CaSO₄, CaCO₃, and CO₂ (gas); and
(12) H₂SO₄, CaSO₄, CaCO₃, CO₂ (gas), and Ca(OH)₂.

Thus, preferably, AGIIS is prepared by mixing calcium hydroxide with concentrated sulfuric acid, with or without an optional Group IIA salt of a dibasic acid (such as calcium sulfate) added to the sulfuric acid. The optional calcium sulfate can be added to the concentrated sulfuric acid prior to the introduction of calcium hydroxide into the blending mixture. The addition of calcium sulfate to the concentrated sulfuric acid appears to reduce the amount of calcium hydroxide needed for the preparation of AGIIS. Other optional reactants include calcium carbonate and gaseous carbon dioxide being bubbled into the mixture. Regardless of the use of any optional reactants, it was found that the use of calcium hydroxide is desirable.

One preferred method of preparing AGIIS can be described briefly as: Concentrated sulfuric acid is added to chilled water (8-12° C.) in the reaction vessel, then, with stirring, calcium sulfate is added to the acid in chilled water to give a mixture. Temperature control is paramount to this process. To this stirring mixture is then added a slurry of calcium hydroxide in water. The solid formed from the mixture is then removed. This method involves the use of sulfuric acid, calcium sulfate, and calcium hydroxide, and it has several unexpected advantages. Firstly, this reaction is not violent and is not exceedingly exothermic. Besides being easy to control and easy to reproduce, this reaction uses ingredients each of which has been reviewed by the U.S. Food and Drug Administration (“U.S. FDA”) and determined to be “generally recognized as safe” (“GRAS”). As such, each of these ingredients can be added directly to food, subject, of course, to certain limitations. Under proper concentration, each of these ingredients can be used as processing aids and in food contact applications. Their use is limited only by product suitability and Good Manufacturing Practices (“GMP”). The AGIIS so prepared is thus safe for animal consumption, safe for processing aids, and safe in food contact applications. Further, the AGIIS reduces biological contaminants in not only inhibiting the growth of, and killing, microorganisms but also destroying the toxins formed and generated by the microorganisms. The AGIIS formed can also preserve, or extend the shelf-life of, consumable products, be they plant, animal, pharmaceutical, or biological products. It also preserves or improves the organoleptic quality of a beverage, a plant product or an animal product. It also possesses certain healing and therapeutic properties.

The sulfuric acid used is usually 95-98% FCC Grade (about 35-37 N). The amount of concentrated sulfuric acid can range from about 0.05 M to about 18 M (about 0.1 N to about 36 N), preferably from about 1 M to about 5 M. It is application specific. The term “M” used denotes molar or moles per liter.

Normally, a slurry of finely ground calcium hydroxide suspended in water (about 50% of W/V) is the preferred way of introducing the calcium hydroxide, in increments, into the a stirring solution of sulfuric acid, with or without the presence of calcium sulfate. Ordinarily, the reaction is carried out below 40° C., preferably below room temperature, and more preferably below 10° C. The time to add calcium hydroxide can range from about 1 hour to about 4 hours. The agitation speed can vary from about 600 to about 700 rpm or higher. After the mixing, the mixture is filtered through a 5 micron filter. The filtrate is then allowed to sit overnight and the fine sediment is removed by decantation.

The calcium hydroxide used is usually FCC Grade of about 98% purity. For every mole of concentrated acid, such as sulfuric acid, the amount, in mole, of calcium hydroxide used is application specific and ranges from about 0.1 to about 1.

The optional calcium carbonate is normally FCC Grade having a purity of about 98%. When used with calcium hydroxide as described above, for every mole of concentrated acid, such as sulfuric acid, the amount, in mole, of calcium carbonate ranges from about 0.001 to about 0.2, depending on the amount of calcium hydroxide used.

The optional carbon dioxide is usually bubbled into the slurry containing calcium hydroxide at a speed of from about 1 to about 3 pounds pressure. The carbon dioxide is bubbled into the slurry for a period of from about 1 to about 3 hours. The slurry is then added to the reaction vessel containing the concentrated sulfuric acid.

Another optional ingredient is calcium sulfate, a Group IIA salt of a dibasic acid. Normally, dihydrated calcium sulfate is used. As used in this application, the phrase “calcium sulfate,” or the formula “CaSO₄,” means either anhydrous or hydrated calcium sulfate. The purity of calcium sulfate (dihydrate) used is usually 95-98% FCC Grade. The amount of calcium sulfate, in moles per liter of concentrated sulfuric acid ranges from about 0.005 to about 0.15, preferably from about 0.007 to about 0.07, and more preferably from about 0.007 to about 0.04. It is application specific.

AGIIS obtained from using the reaction of H₂SO₄/Ca(OH)₂2/CaSO₄4 had the following analyses (average):
AGIIS with Final Acid Normality of 1.2 N, pH of −0.08
H₃O⁺, 2.22%; Ca, 602 ppm; SO₄, 73560 ppm; K, 1.36 ppb; impurities of 19.68 ppm, and neither Na nor Mg was detected.
AGIIS with Final Acid Normality of about 29 N pH of about −1.46
H₃O⁺, 30.68%; Ca, 52.9 ppm; SO₄4,7356000 ppm; K, 38.02 ppb; and neither Na nor Mg was detected.

Besides concentrated sulfuric acid, other polyprotic acids, such as phosphoric acid, phosphorous acid, chloric acid, iodic acid, or others can be used.

Likewise, aqueous solutions of other alkalines or bases, such as Group IA hydroxide solution or slurry and Group IIA hydroxide solution or slurry can be used. Groups IA and IIA refer to the two Groups in the periodical table. The use of Group IIA hydroxide is preferred. Preferably, the salts formed from using Group IIA hydroxides in the reaction are sparingly-soluble in water. It is also preferable to use only Group IIA hydroxide as the base without the addition of Group IA hydroxide.

After the reaction, the resultant concentrated acidic solution with a relatively low pH value, typically below pH 1, can then be diluted with de-ionized water to the desired pH value, such as pH of about 1 or about 1.8.

However, it is sometimes desirable not to prepare a very concentrated AGIIS solution and then dilute it serially to obtain the solution having the desired final acid normality. It is often desirable to prepare a solution of AGIIS having a desired final pre-determined acid normality according to the method described in this application so that not much dilution of the product is required before use.

AGIIS has relatively less dehydrating properties (such as charring sucrose) as compared to the saturated solution of CaSO₄4 in the same concentration of H₂SO₄. Further, the stability and non-corrosive nature of the AGIIS of the present invention can be illustrated by the fact that a person can put his or her hand into this solution with a pH of less than 0.5 and, yet, his or her hand suffers no irritation, and no injury. If, on the other hand, one places his or her hand into a solution of sulfuric acid Of pH of less than 0.5, an irritation would occur within a relatively short span of time. A solution of 28 N of sulfuric acid saturated with calcium sulfate will cause chemical burn to a human skin after a few seconds of contact. In contrast, AGIIS solution of the same normality would not cause chemical burn to a human skin even after in contact for 5 minutes. The AGIIS of the present invention does not seem to be corrosive when being brought in contact with the environmental protective covering of plants (cuticle) and animals (skin). AGIIS is non-volatile at room temperature. Even as concentrated as 29 N, the AGIIS has no odor, does not give off fumes in the air, and is not irritating to a human nose when one smells this concentrated solution.

The AGIIS products may advantageously be formulated with an additive to form adducts. Preferred additives appear to be synergistic to the effectiveness of the AGIIS. Examples of the additives include alcohol, organic acid, periodic acid, and surfactant. The amount of additive added to the AGIIS varies depending on the desired final weight percent of the additive in the final adduct composition. The weight percent of additive needed for the adduct composition of the present invention can vary from about 0.01 to about 99.99, based on the total weight of the final adduct composition. In one aspect, if the additive is to be added to the concentrated AGIIS with a very low pH value, then the amount of the additive added has to be adjusted in anticipation of further dilution with water to raise the pH value of the final adduct composition. The alcohol additive preferred for the present invention includes methanol, ethanol, propanol, i-propanol, and other lower alkyl alcohols.

Organic acid additive of the present invention includes carboxylic acid. A carboxylic acid is an organic compound containing the —COOH group, i.e., a carbonyl attached to a hydroxyl group. Preferred organic acids for the present invention include C8-C22 fatty acids, C2-C6 mono- and dicarboxylic acids (acetic acid, propionic acid, lactic acid, oxalic acid, and peracetic acid).

A surfactant for the present invention is a surface-active agent. It is usually an organic compound consisting of two parts: One, a hydrophobic portion, usually including a long hydrocarbon chain; and two, a hydrophilic portion which renders the compound sufficiently soluble or dispersible in water or another polar solvent. Surfactants are usually classified into: (1) anionic, where the hydrophilic moiety of the molecule carries a negative charge; (2) cationic, where this moiety of the molecule carries a positive charge; and (3) nonionic, which do not dissociate, but commonly derive their hydrophilic moiety from polyhydroxy or polyethoxy structures. Other surfactants include ampholytic and zwitterionic surfactants. A preferred surfactant for the present invention includes polysorbates (Tween 80).

Unless otherwise defined, the amount of each ingredient or component of the present invention is based on the weight percent of the final composition, usually the concentrate before further dilution to achieve the desired pH of about 1.8. The AGIIS having a pH of about 1.8 is usually further diluted with water before applying to an animal product or a plant product.

One way of preparing a concentrate of the AGIIS having an ethanol additive and a lactic acid additive is by mixing with stirring at ambient temperature 634 mL of 200 proof FCC ethanol (16.5 weight %); 75 mL. of 85% lactic acid (1.9 weight %); 1536 mL of a solution of AGIIS having a pH of about 0.2-0.4 (40 weight %); and 1595 mL of de-ionized water (41.5 weight %). The resultant concentrate of AGIIS with two additives showed a pH of about 1.65-1.8.

One way of preparing a concentrate of the AGIIS having ethanol, lactic, and Tween 80 additives is by mixing with stirring at ambient temperature 634 mL of 200 proof FCC ethanol (16.5 weight %); 75 mL. of 85% lactic acid (1.9 weight %); 1920 mL of a solution of AGIIS having a pH of about 0.2-0.4 (50 weight %); 255 mL of Tween 80 (6.6 weight %); and 957.6 mL of de-ionized water (25 weight %). The resultant concentrate of AGIIS with three additives showed a pH of about 1.45-1.7.

Another useful acidulent is a composition of a highly acidic metalated organic acid (“HAMO”) as described in U.S. patent application Publication No. US2003/0087014 incorporated by reference herein. The composition may have a suspension of very fine particles, and it has a monovalent or a polyvalent cation, an organic acid, and an anion of a regenerating acid, such as the anion of a strong oxyacid. The term “highly acidic” means the pH is in the acidic region, below at least about 4, preferably 2.5. HAMO of the present invention is less corrosive to a ferrous metal than a solution of a mineral acid having the same acidic pH value as that of the acidic composition. HAMO is also more biocidal than a mixture of the organic acid and a metal salt of the organic acid which mixture having the same acid normality value as that of the acidic composition.

Broadly, one way HAMO can be prepared is by mixing the following ingredients: (1) at least one regenerating acid; (2) at least one metal base; and (3) at least one organic acid, wherein the equivalent amount of the regenerating acid is in excess of the equivalent amount of the metal base. The equivalent amount of the metal base should be about equal to that of the organic acid. Instead of using a metal base and an organic acid, a metal salt of the organic acid can be used in place of the metal base and the organic acid. The insoluble solid is removed by any conventional method, such as sedimentation, filtration, or centrifugation.

Generally, HAMO can be prepared by blending or mixing the necessary ingredients in at least the following manners:
1. Regenerating acid+(metal base+organic acid);
2. Regenerating acid+(metal base+salt of organic acid);
3. (Regenerating acid+salt of organic acid)+base; and
4. Regenerating acid+salt of organic acid.

The parenthesis in the above scheme denotes “pre-mixing” the two ingredients recited in the parenthesis. Normally, the regenerating acid is added last to generate the HAMO. Although each of the reagents is listed as a single reagent, optionally, more than one single reagent, such as more than one regenerating acid or organic acid, can be used in the current invention. The number of equivalents of the regenerating acid must be larger than the number of equivalents of the metal base, or those of the metal salt of the organic acid. When the organic acid is an amino acid, which, by definition contains at least one amino group, then the number of equivalents of the regenerating acid must be larger than the total number of equivalents of the metal base, or metal salt of the organic acid, and the “base” amino group of the amino acid. Thus, the resultant highly acidic metalated organic acid is different from, and not, a buffer. See, “Highly Acidic Metalated Inorganic Acid,” U.S. application Ser. No. 09/655,131, filed Sep. 5, 2000, the entire content of which is hereby incorporated by reference.

As used herein, a regenerating acid is an acid that will “re-generate” the organic acid from its salt. Examples of a regenerating acid include a strong binary acid, a strong oxyacid, and others. A binary acid is an acid in which protons are directly bound to a central atom, that is (central atom)-H. Examples of a binary acid include HF, HCl, HBr, HI, H₂S and HN₃. An oxyacid is an acid in which the acidic protons are bound to oxygen, which in turn is bound to a central atom, that is (central atom)-O—H. Examples of oxyacid include acids having Cl, Br, Cr, As, Ge, Te, P, B, As, I, S, Se, Sn, Te, N, Mo, W, or Mn as the central atom. Some examples include H₂SO₄, HNO₃, H₂SeO₄, HClO₄, H₃PO₄, and HMnO₄. Some of the acids (e.g. HMnO₄) cannot actually be isolated as such, but occur only in the form of their dilute solutions, anions, and salts. A “strong oxyacid” is an oxyacid, which at a concentration of 1 molar in water gives a concentration of H₃O⁺ greater than about 0.8 molar.

The regenerating acid can also be an acidic solution of sparingly-soluble Group IIA complexes (“AGIIS”) described above. Also, the HAMO acidulents can be used to form adducts with the performance-enhancing additives of the same type described above relative to the AGIIS products.

One embodiment of the present invention involves a highly acidic metalated mixture of inorganic acids (“HAMMIA”). The composition has an acidic pH, and can be isolated from a mixture prepared by mixing ingredients comprising a salt of phosphoric acid, and a preformed, or in-situ generated, solution or suspension of an acidic sparingly-soluble Group IIA complex (“AGIIS”), wherein the solution or suspension of AGIIS is in an amount sufficient to render the acidic pH of the composition to be less than about 2. Another embodiment of the present invention involves a composition having an acidic pH, the composition is isolated from a mixture prepared by mixing ingredients comprising a salt of phosphoric acid, and a preformed, or in-situ generated, solution or suspension of AGIIS, wherein the solution or suspension of AGIIS is in an amount in excess of the amount required to completely convert the salt of phosphoric acid to phosphoric acid. Still another embodiment of the present invention involves an adduct which contains an additive and the acidic composition of the present invention. Other aspects of the present invention pertain to a prepared nutriment containing a nutriment material and absorbed therein or adsorbed thereon is the acidic composition or the adduct of the present invention. Another aspect of the present invention involves method to reduce biological contaminants in a nutriment material.

The following examples set forth preferred products and methods in accordance with the invention. It is to be understood, however, that these examples are provided by way of illustration and nothing therein should be taken as a limitation upon the overall scope of the invention.

### EXAMPLE 1

In this example, precooked extruded pasta and rice products were prepared containing a preferred acidulent, with non-acidulated controls.

Pasta

The pasta formulation contained 99.25% by weight Durum flour, and 0.75% by weight Myvaplex surfactant. The acidulent was a liquid ACS product obtained from Mionix Corporation of Rocklin, Calif. It is commercialized as “Safe 20-110,” and is made up of ACS 50 (another Mionix acidulated calcium sulfate product) and gluconic acid. The extruder employed was a Wenger Model TX57 having a total of five heads with a Wenger Model 2DDC preconditioner upstream of the extruder. A die for producing 0.025 inch elbow macaroni was employed with a die spacer between the end of the barrel and the macaroni die. The heads of the extruder and the die spacer were temperature controlled using cold water (CW) or hot oil (HO), and wherein the first numerical entry in the following Tables refers to the temperature of oil or water, and the second entry refers to the actual measured temperature at the corresponding location. Water and steam were injected into the preconditioner, and steam was injected into the extruder barrel. A rotating knife was positioned adjacent the outlet of the die for cutting the extrudate into appropriate lengths. In the control Run #1, no acidulent was used. In Run #2, liquid acidulent was pumped into the last port of the preconditioner prior to entry of the preconditioned material into the extruder. The following table sets forth the conditions of these two Runs.

TABLE 1

| | | RUN #1 | RUN #2 |
|---|---|---|---|
| DRY RECIPE INFORMATION: | | | |
| Dry Recipe Density | kg/m³ | 575 | 575 |
| Feed Screw Speed | rpm | 25 | 25 |
| PRECONDITIONING | | | |
| INFORMATION: | | | |
| Preconditioner Speed | rpm | 150 | 150 |
| Steam Flow to Preconditioner | kg/hr | 46.1 | 46.2 |
| Water Flow to Preconditioner | kg/hr | 34.38 | 28.94 |
| Preconditioner Acidulent Additive | kg/hr | — | 306 |
| Rate | | | |
| Preconditioner Discharge Temp. | C.° | 101 | 101 |
| Moisture Entering Extruder | % wb | 35.99 | 37.66 |
| EXTRUSION INFORMATION: | | | |
| Extruder Shaft Speed | rpm | 160 | 160 |
| Motor Load | % | 36 | 33 |
| Steam Flow to Extruder | kg/hr | 11.3 | 12.1 |
| Control/Temperature-1st Head | ° C. | CW/70/71 | CW/70/70 |
| Control/Temperature-2nd Head | ° C. | HO/110/111 | HO/110/105 |
| Control/Temperature-3rd Head | ° C. | HO/110/111 | HO/110/110 |
| Control/Temperature-4th Head | ° C. | CW/99/82 | CW/90/90 |
| Control/Temperature-5th Head | ° C. | CW/90/88 | CW/90/90 |
| Control/Temperature-Die Spacer | ° C. | HO/90/85 | HO/90/85 |
| Head Pressure-Head 5 | kPa | 5/3447.5 | 5/3101.75 |
| Die Pressure | kPa | 550 | 500 |
| Knife Drive Speed | rpm | 5 | 5 |
| FINAL PRODUCT | | | |
| INFORMATION: | | | |
| Extruder Discharge Rate | kg/hr | 162 | 162 |
| Extruder Discharge Moisture | % wb | 38.25 | 36.74 |
| Product Acidity | pH | — | 4.44 |

After the two extrusion runs, a portion of the cut extrudate from each run was dried using a two-pass Wenger 4800 dryer at 80° C. to approximately 12% by weight wet basis and packaged using a Multi-Vac packaging machine. Another portion of each extrudate was collected off the extruder at approximately 32-33% by weight water wet basis, placed into plastic bags, sealed and transferred to a packaging area. The product was transferred to the Multi-Vac packaging machine and packaged with nitrogen flush and a slight vacuum to minimize head space. Finally, another portion of each extrudate was collected, transferred to boiling water for 2 minutes, strained and transferred to the Multi-Vac packaging machine and packaged with nitrogen flush and a slight vacuum. The control sample had a moisture content of 56.46% by weight wet basis, whereas the treated sample had a moisture content of 55.55% by weight wet basis.

It was expected based on previous experience with acidified products that the acidulated test products would be very sticky owing to the low pH thereof, and would taste very acidic. However, it was noted that the test products had very little noticeable stickiness and no acid test or flavor.

Rice

In this series of tests, a recipe containing 99.25% by weight rice flour and 0.75% by weight Dimodan surfactant was employed. Four separate acidulents were used during the course of the run, namely: (Run #4A) the acidulent used in the above pasta example, added at a rate of 3.6 kg acidulent/hour/150 kg of rice flour, yielding a final product with a pH of 4.41; (Run #4B) a blend of 25% lactic acid and 75% ACS 50 (V/V), added at a rate of 354 kg/hour/150 kg rice flour, giving a product which upon grinding had an HPLC analysis of 35499.8 ppm lactate and 10206.2 sulfate, and a pH of 1.65; (Run #4C) a blend of 25% propionic acid and 75% ACS 50 (V/V), added at a rate of 34 kg/hour/150 kg rice flour, giving an HPLC analysis of 11521.9 ppm propionate and 29187.5 ppm sulfate, and a final pH of 1.14; and (Run #4D) straight ACS 50 (39.12 kg) blended with 6.72 kg water, with the blend being added at 45.84 kg/hour/150 kg rice flour, and wherein the product had an HPLC analysis of 35499.8 ppm sulfate and a pH of 0.74. The liquid acidulents were pumped into the last port of the preconditioner. A two-head Wenger TX57 extruder was employed along with a Wenger Model 2DDC preconditioner and a Wenger 4800 dryer. Steam and water were injected into the preconditioner during the runs. The die employed produced a simulated long grain rice product. The following Table 2 sets forth the conditions for these Runs 3 (control) and 4A (acidulated).

TABLE 2

| | | RUN #3 | RUN #4A |
|---|---|---|---|
| DRY RECIPE INFORMATION: | | | |
| Dry Recipe Density | kg/m³ | 630 | 630 |
| Dry Recipe Rate | kg/hr | 150 | 150 |
| Feed Screw Speed | rpm | 29 | — |
| PRECONDITIONING | | | |
| INFORMATION: | | | |
| Preconditioner Speed | rpm | 150 | 150 |
| Steam Flow to Preconditioner | kg/hr | 30 | 30 |
| Water Flow to Preconditioner | kg/hr | 40.68 | 38.28 |
| Preconditioner Acidulated Additive | kg/hr | — | 3.6 |
| Rate | | | |
| Preconditioner Discharge Temp. | C.° | 90 | 91 |
| Moisture Entering Extruder | % wb | 31.16 | 34.93 |
| EXTRUSION INFORMATION: | | | |
| Extruder Shaft Speed | rpm | 160 | 160 |
| Motor Load | % | 39 | 42 |
| Control/Temperature-1st Head | ° C. | HO/90/90 | HO/90/90 |
| Control/Temperature-2nd Head | ° C. | HO/90/90 | HO/90/90 |
| Die Spacer Temperature | ° C. | HO/90/87 | HO/90/87 |
| Head Pressure-2nd Head | kPa | 2758 | 2758 |
| Knife Drive Speed | rpm | 50 | 62 |
| FINAL PRODUCT | | | |
| INFORMATION: | | | |
| Extruder Discharge Moisture | % wb | 33.47 | 29.85 |

In other rice extrusion runs, a starting recipe made up of 99.05% by weight rice flour, 0.75% byweightDimodanand 0.20% byweightpotassium sorbate was employed. Theacidulent used in Run #4A was employed by injection into the preconditioner at the last port thereof, and the equipment employed was also the same as in the previous rice runs. An untreated control rice was also produced using essentially the same conditions as the acidulent/sorbate treated rice. The following table sets forth the conditions of the treated rice Run #5.

TABLE 3

| | | RUN #5 |
|---|---|---|
| DRY RECIPE INFORMATION: | | |
| Dry Recipe Rate | kg/hr | 150 |
| Feed Screw Speed | rpm | 27 |
| PRECONDITIONING INFORMATION: | | |
| Preconditioner Speed | rpm | 150 |
| Steam Flow to Preconditioner | kg/hr | 34 |
| Water Flow to Preconditioner | kg/hr | 38.7 |
| Preconditioner Acidulent Additive Rate | kg/hr | 3.6 |
| Preconditioner Discharge Temp. | C° | 195 |
| EXTRUSION INFORMATION: | | |
| Extruder Shaft Speed | rpm | 160 |
| Motor Load | % | 34 |
| Control/Temperature-1st Head | ° C. | HO/90/90 |
| Control/Temperature-2nd Head | ° C. | HO/90/90 |
| Head Pressure-2nd Head | kPa | 2/3102.75 |
| Knife Drive Speed | rpm | 49 |
| FINAL PRODUCT INFORMATION: | | |
| Extruder Discharge Rate | kg/hr | 200 |

Samples of the control and acidulent/sorbate treated extrudates were collected and boiled for 2 minutes in a steam kettle, drained for 2 minutes and packaged in a modified atmosphere (gas flushed with nitrogen) using a Multi-Vac packaging machine. The samples were collected and microbiological quality (AnAerobic Plate Counts, AnPC; Yeast Count and Mold Count) were evaluated on days 0, 5, 8, 14 and 21 days. General product appearance and visual score was performed to evaluate the product appearance, leakers and mold growth on days 14, 21, 29 and 47 of storage at room temperature. Gas composition in the bags was analyzed on day 21 to evaluate changes in gas composition during storage.

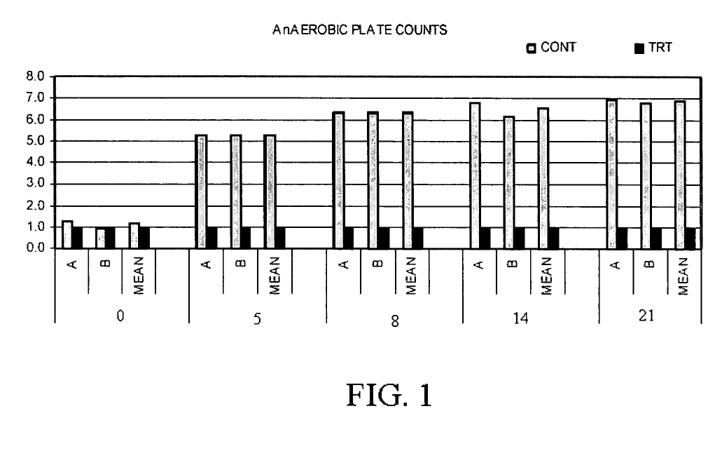

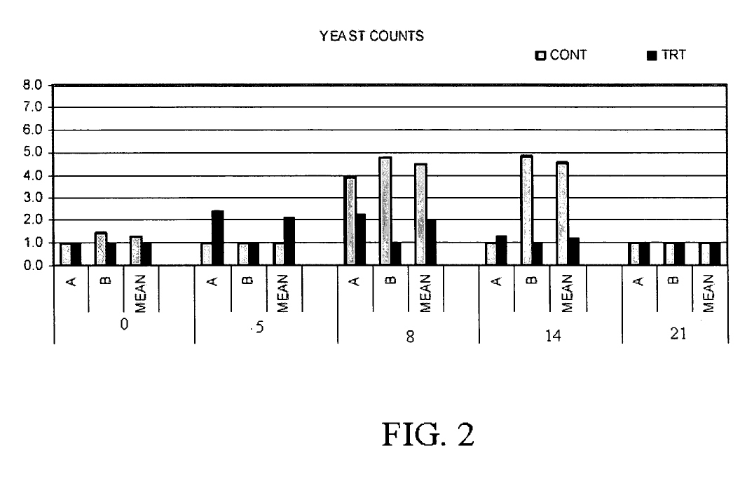

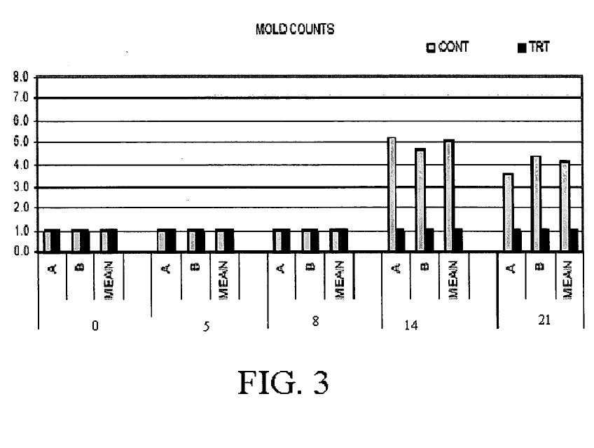

The anaerobic plate counts (AnPCs; FIG. 1) of the control samples were 1.15, 5.30, 6.30, 6.55 and 6.89 log CFU/g on days 0, 5, 8, 14 and 21 days of storage at room temperature, respectively. The AnPCs of the treated samples remained below the detection level (<0.95 log CFU/g) throughout the storage period. The yeast counts (YCs; FIG. 2) of the control samples were 1.28, 0.95, 4.51, 4.53 and 0.95 log CFU/g at each of the storage periods; while lower YCs were observed for the treated samples (0.95, 2.06, 1.97, 1.15 and 0.95 log CFU/g for each of the storage periods). The variation within the YCs in the treated samples could be due to sampling unit differences. The mold counts (MCs; FIG. 3) increased from below the detection limit (<0.95 log CFU/g) to ca. 4 log CFU/g by day 21 in the control sample, while the MCs remained below the detection limit over the entire storage period.

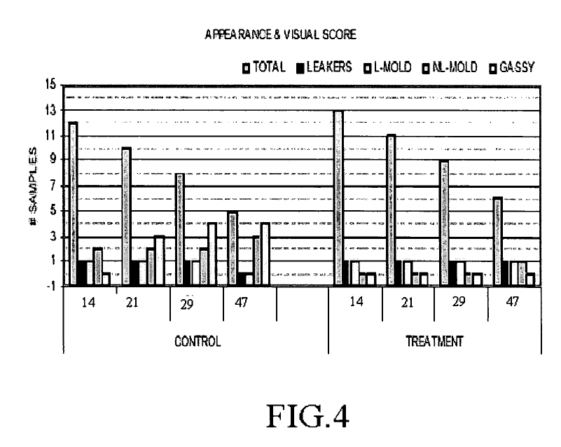

Mold growth in all the treated samples (except 1 bag on day 47) was due to leakers and gassiness was not observed. However, in control samples, mold growth was observed on 14, 21, 29 and 47 days (2, 2, 2 and 3 samples, respectively), along with gassiness (blown samples) on 21, 29 and 47 days (3, 4 and 4 samples respectively). In addition, slimy gray and yellow appearance (FIG. 4) was observed on one sample each of the controls, while the treated samples did not show any discoloration. pH of the control and treated samples was 6.48 and 4.15, respectively.

In another series of rice runs, a recipe made up of 92.5% by weight rice flour and 7.5% by weight Dimodan was employed. The equipment employed in these runs is identical to that used in connection with the other rice runs above. The acidulent used is the same as that of Run #4A and was added at the last port of the preconditioner. In this case, a liquid potassium sorbate solution was employed, made up of 97.39% by weight water and 2.61% by weight potassium sorbate; this additive was also injected into the preconditioner, but at the first port near the preconditioner inlet.

The following table sets forth the conditions of these Runs #6-15.

TABLE 4

| | | Run #6 | Run #7 | Run #8 | Run #9 | Run #10 | Run #11 | Run #12 | Run #13 | Run #14 | Run #15 |
|---|---|---|---|---|---|---|---|---|---|---|---|
| DRY RECIPE | | | | | | | | | | | |
| INFORMATION: | | | | | | | | | | | |
| Dry Recipe Density | kg/m³ | 575 | 575 | 575 | 575 | 575 | 575 | 575 | 575 | 575 | — |
| Dry Recipe Rate | kg/hr | 120 | 120 | 120 | 120 | 120 | 120 | 120 | 120 | 120 | 120 |
| Feed Screw Speed | rpm | 21 | 21 | 21 | 21 | 21 | 21 | 21 | 21 | 21 | 22 |
| PRE- | | | | | | | | | | | |
| CONDITIONING | | | | | | | | | | | |
| INFORMATION: | | | | | | | | | | | |
| Preconditioner | rpm | 150 | 150 | 150 | 150 | 150 | 150 | 150 | 150 | 150 | 150 |
| Speed | | | | | | | | | | | |
| Steam Flow to | kg/hr | 28 | 28 | 28 | 28 | 29 | 30 | 26 | 27 | 27 | 32 |
| Preconditioner | | | | | | | | | | | |
| Water Flow to | kg/hr | 33.6 | 33.6 | 33.6 | 33.6 | 24.9 | 24.9 | 33.6 | 24.9 | 24.9 | 24.9 |
| Preconditioner | | | | | | | | | | | |
| Preconditioner | ° C. | 25 | 25 | 25 | 25 | 25 | 25 | 25 | 25 | 25 | 25 |
| Water Temp | | | | | | | | | | | |
| Preconditioner | kg/hr | — | 9 | 9 | — | 9 | 9 | — | 9 | 9 | 9 |
| Sorbate Additive | | | | | | | | | | | |
| Rate | | | | | | | | | | | |
| Preconditioner | ° C. | — | 25 | 25 | — | 25 | 25 | — | 25 | 25 | 25 |
| Sorbate Additive | | | | | | | | | | | |
| Temp | | | | | | | | | | | |
| Preconditioner | kg/hr | — | — | 2.94 | — | — | 2.94 | — | — | 2.94 | 2.94 |
| Acidulent Additive | | | | | | | | | | | |
| Rate | | | | | | | | | | | |
| Preconditioner | ° C. | — | — | — | — | — | 25 | — | — | 25 | 25 |
| Acidulent Additive | | | | | | | | | | | |
| Temp | | | | | | | | | | | |
| Preconditioner | ° C. | 91 | 91 | 91 | 91 | 90 | 89 | 90 | 91 | 89 | 96 |
| Discharge Temp | | | | | | | | | | | |
| Moisture Entering | % wb | 29.27 | 33.57 | 33.82 | 31.7 | 32.65 | 31.16 | 31.21 | 31.96 | 32.25 | 38.91 |
| Extruder | | | | | | | | | | | |
| EXTRUSION | | | | | | | | | | | |
| INFORMATION: | | | | | | | | | | | |
| Extruder Shaft | rpm | 160 | 160 | 160 | 160 | 160 | 160 | 160 | 160 | 160 | 170 |
| Speed | | | | | | | | | | | |
| Extruder Motor | % | 39 | 37 | 34 | 30 | 39 | 34 | 35 | 35 | 32 | 25 |
| Load | | | | | | | | | | | |
| Control/ | ° C. | HO/90/90 | HO/90/90 | HO/90/90 | HO/90/90 | HO/90/90 | HO/90/90 | HO/90/90 | HO/90/90 | HO/90/90 | HO/90/90 |
| Temperature-1st | | | | | | | | | | | |
| Head | | | | | | | | | | | |
| Control/ | ° C. | HO/90/89 | HO/90/90 | HO/90/90 | HO/90/90 | HO/90/90 | HO/90/90 | HO/90/90 | HO/90/90 | HO/90/90 | HO/90/90 |
| Temperature-2nd | | | | | | | | | | | |
| Head | | | | | | | | | | | |
| Control/ | ° C. | HO/90/86 | HO/90/86 | HO/90/85 | HO/90/85 | HO/90/86 | HO/90/85 | HO/90/86 | HO/90/86 | HO/90/86 | HO90 |
| Temperature | | | | | | | | | | | |
| Die Spacer | | | | | | | | | | | |
| Head/Pressure | kPa | 2/2758 | 2/2758 | 2/2758 | 2/2758 | 2/2758 | 2/2758 | 2/2758 | 2/2758 | 2/2758 | 2/2413.25 |
| Die/Pressure | psi | 450 | 400 | 400 | 450 | 400 | 400 | 450 | 400 | 400 | — |
| FINAL PRODUCT | | | | | | | | | | | |
| INFORMATION: | | | | | | | | | | | |
| Extruder Discharge | % wb | 30.75 | 31.58 | — | 30.58 | 31.3 | 33.21 | 32.6 | 32.21 | 32.94 | 35.58 |
| Moisture | | | | | | | | | | | |

### EXAMPLE 2

In this example, a series of grain and starch products were acidulated using preferred acidulents in accordance with the invention.

Wheat Flour

In this series of runs, a recipe made up of 100% Buccaneer flour was extruded and an acidulent solution or potassium sorbate was added in order to yield encapsulated acidulent and preservative flour. The equipment employed was identical to that used in the above-described rice Runs #3-15, except that a conventional pelleting die was used in lieu of the rice die. In Run #16, the additive was an acidulent made up of 10% lactic acid/90% ACS 50 (V/V), with a product having an HPLC analysis of 7482.5 lactate and 17471.1 ppm sulfate; in Runs #17 and 18, the additive was a 40% by weight potassium sorbate/60% by weight water solution; in Run #19, the additive was a solution containing 10% by weight WSafe 20-110/90% by weight water. The following table sets forth the results of these runs.

TABLE 5

| | | Run #16 | Run #17 | Run #18 | Run #19 |
|---|---|---|---|---|---|
| DRY RECIPE INFORMATION: | | | | | |
| Dry Recipe Rate | kg/hr | 140 | 140 | 90 | 90 |
| Feed Screw Speed | rpm | 30 | 30 | 22 | 22 |
| PRECONDITIONING INFORMATION: | | | | | |
| Preconditioner Speed | rpm | 150 | 150 | 150 | 150 |
| Water Flow to Preconditioner | kg/hr | 29.94 | — | 9.6 | 9.6 |
| Preconditioner Water Temp | ° C. | 25 | — | — | — |
| Preconditioner Sorbate Additive Rate | kg/hr | — | 69.6 | 40.2 | — |
| Preconditioner Sorbate Additive Temp | ° C. | — | 25 | 25 | — |
| Preconditioner Acidulent Additive Rate | kg/hr | 15.24 | — | — | 40.2 |
| Preconditioner Acidulent Additive Temp | ° C. | 25 | — | — | 25 |
| Preconditioner Discharge Temp | ° C. | 28 | 82 | 32 | 32 |
| Moisture Entering Extruder | % wb | — | 37.89 | — | — |
| EXTRUSION INFORMATION: | | | | | |
| Extruder Shaft Speed | rpm | 185 | 200 | 200 | 200 |
| Extruder Motor Load | % | 85 | 50 | 50 | 50 |
| Control/Temperature-1st Head | ° C. | HO/40/65 | HO/40/66 | HO/40/65 | HO/40/65 |
| Control/Temperature-2nd Head | ° C. | HO/40/62 | HO/40/64 | HO/40/63 | HO/40/63 |
| Control/Temperature Die Spacer | ° C. | HO/60/60 | HO/60/60 | HO/90/90 | HO/90/90 |
| Head/Pressure | kPa | 2/4481.75 | 2/4826.5 | 2/4826.5 | 2/4826.5 |
| Die/Pressure | psi | 700 | 700 | 350 | 350 |
| FINAL PRODUCT INFORMATION: | | | | | |
| Extruder Discharge Moisture | % wb | — | 25.86 | 26.4 | 26.4 |

In another Run #20, another wheat flour (H&R All Purpose Wheat Flour) was used and the additive was the acidulent of Run #16 added in the last port of the preconditioner. The following sets forth the extrusion conditions.

TABLE 6

| | | Run #20 |
|---|---|---|
| DRY RECIPE INFORMATION: | | |
| Dry Recipe Rate | kg/hr | 140 |
| Feed Screw Speed | rpm | 30 |
| PRECONDITIONING INFORMATION: | | |
| Preconditioner Speed | rpm | 150 |
| Water Flow to Preconditioner | kg/hr | 29.94 |
| Preconditioner Water Temp | ° C. | 25 |
| Preconditioner Acidulent Additive Rate | kg/hr | 15.24 |
| Preconditioner Acidulent Additive Temp | ° C. | 25 |
| Preconditioner Discharge Temp | ° C. | 27 |
| Moisture Entering Extruder | % wb | — |
| EXTRUSION INFORMATION: | | |
| Extruder Shaft Speed | rpm | 185 |
| Extruder Motor Load | % | 65 |
| Control/Temperature-1st Head | ° C. | HO/40/41 |
| Control/Temperature-2nd Head | ° C. | HO/40/40 |
| Control/Temperature Die Spacer | ° C. | HO/60/56 |
| Head/Pressure | kPa | 2/4137 |
| Die/Pressure | psi | 650 |

Pregelled Corn Starch

Two extrusion Runs #21 and 22 were carried out using the same equipment as the wheat flour runs, using 100% by weight B998 Dura-Gel Pregelled Corn Starch as the basic substrate. In Run #21, the additive was made up of 10% lactic acid/90% ACS 50 (V/V) diluted at a level of 2.8 L of the foregoing acidulent in 40 L water, giving a product having an HPLC analysis of 2672.7 ppm lactate and 5974.8 ppm sulfate. In Run #22, the additive was Mionix Safe2o-RTE-01, giving a product having an HPLC analysis of 120489.4 ppm lactate, 6955.6 ppm sulfate and 5077.1 ppm phosphate. The following table sets forth the extrusion conditions for these runs.

TABLE 7

| | | Run #21 | Run #22 |
|---|---|---|---|
| DRY RECIPE INFORMATION: | | | |
| Dry Recipe Rate | kg/hr | 70 | 70 |
| Feed Screw Speed | rpm | 20 | 20 |
| PRECONDITIONING INFORMATION: | | | |
| Preconditioner Speed | rpm | 150 | 150 |
| Preconditioner Acidulent Additive Rate | kg/hr | 30 | 30.6 |
| Preconditioner Acidulent Additive Temp | ° C. | 25 | 25 |
| Preconditioner Discharge Temp | ° C. | 31 | 32 |
| EXTRUSION INFORMATION: | | | |
| Extruder Shaft Speed | rpm | 160 | 160 |
| Extruder Motor Load | % | 46 | 55 |
| Control/Temperature-1st Head | ° C. | HO/40/47 | HO/40/56 |
| Control/Temperature-2nd Head | ° C. | HO/40/45 | HO/40/53 |
| Control/Temperature Die Spacer | ° C. | HO/60/54 | HO/60/58 |
| Head/Pressure | kPa | 2/2413.25 | 2/3102.75 |
| Die/Pressure | psi | 500 | 450 |

Corn Starch

One extrusion Run #23 was carried out using straight corn starch (B-700) as the primary substrate. The additive was a solution containing 10% by weight WSafe 20-110/90% water, added into the preconditioner. The equipment was the same as used in the wheat flour runs, and yielded a product having a HPLC analysis of 6794.5 ppm gluconate and 3662.2 ppm sulfate. The following table sets forth the extrusion conditions for this run.

TABLE 8

| | | Run #23 |
|---|---|---|
| DRY RECIPE INFORMATION: | | |
| Dry Recipe Rate | kg/hr | 70 |
| Feed Screw Speed | rpm | 20 |
| PRECONDITIONING INFORMATION: | | |
| Preconditioner Speed | rpm | 150 |
| Preconditioner Acidulent Additive Rate | kg/hr | 30 |
| Preconditioner Acidulent Additive Temp | ° C. | 25 |
| Preconditioner Discharge Temp | ° C. | 32 |
| EXTRUSION INFORMATION: | | |
| Extruder Shaft Speed | rpm | 60 |
| Extruder Motor Load | % | 58 |
| Control/Temperature-1st Head | ° C. | HO/40/61 |
| Control/Temperature-2nd Head | ° C. | HO/40/58 |
| Control/Temperature Die Spacer | ° C. | HO/60/58 |
| Head/Pressure | kPa | 2/2068.5 |
| Die/Pressure | psi | 400 |
| FINAL PRODUCTION INFORMATION: | | |
| Extruder Discharge Moisture | % wb | 32.08 |

### EXAMPLE 3

In this example, cookie dough products were prepared in accordance with the invention and tested for shelf stability.

In particular, conventional double chocolate chip cookie dough formulations were prepared, by blending the dough ingredients followed by addition of chocolate chips pursuant to the normal recipe. A 15 pound batch of the dough ingredients was treated with two Mionix Corporation's acidulents, MC-586 (95 ml) and MPA-75 (51 ml); At this point, 4.23 pounds of chocolate chips were added and dispersed throughout the dough. The control dough was made without addition of the acidulents. One-half dough portions from the control and treated dough were placed in individual containers. Eight control and 8 treated portions were palced in an incubator set at 30° C., and one control and one treated sample was maintained at ambient temperature for 24 hours. After the 24-hour hold time, initial baseline microbial levels were assessed.

One sample from each group was removed from the incubator at weekly intervals for microbial assessment. For test purposes, three 25 g samples from each container were extracted and placed separately in stomacher bags along with 25 ml of phosphate buffer (pH 7.4). The individual samples were massaged briefly to emulsify the cookie dough and then treated for 2 minutes at normal speed using a Seward Stomacher 400. An aliquot from each bag was then removed and serially diluted, and an aliquot from each serial dilution was placed onto a petri dish. The dishes were incubated at the 37° C. for 48 hours, at which time the colony forming units for each sample were determined. The following sets forth the results of this series of tests.

TABLE 9
Results:

| Weeks | Control CFU/g | Treated CFU/g |
|---|---|---|
| 0 | 1.66E+03 | 8.52E+02 |
| 1 | 3.08E+05 | 6.56E+02 |
| 2 | 8.81E+06 | 7.73E+02 |
| 3 | 6.45E+06 (Mold) | 7.20E+02 |
| 4 | 1.09E+07 (Mold) | 8.44E+02 |
| 5 | 5.70E+06 (Mold) | 7.87E+02 |
| 6 | 3.03E+06 (Mold) | 9.82E+02 |
| 7 | (Mold) | 1.04E+03 |
| 8 | (Mold) | 1.36E+03 |

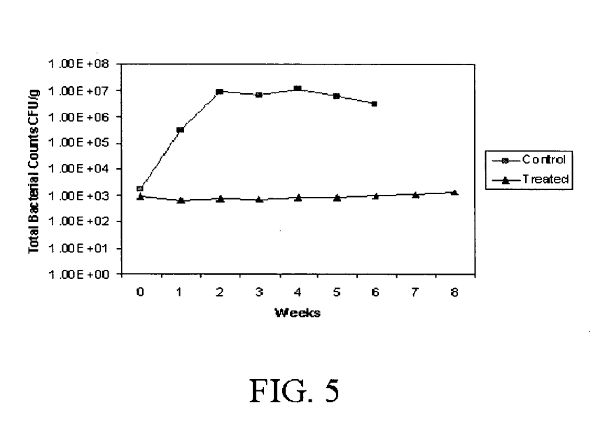

The objective of this study was to determine the effect of the addition of the acidulents on the shelf life of the cookie dough product. As confirmed by the foregoing data and FIG. 5, the CFU/g remained stable over the entire 8-week period for the treated dough whereas bacterial counts increased until the fourth week for the untreated samples. In addition, the untreated samples became moldy by the third week. Microbial assessment was stopped by week 7 for the untreated samples, because the product was determined to be rotten. This study clearly demonstrates that treatment with the acidulents preserves the shelf life of cookie dough under ambient storage conditions.

Additional chocolate chip cookie dough formulations were prepared using the acidulated and sorbate-treated wheat flours produced above in Runs #20 and 18, respectively. In particular, the following Table 9 sets forth control and treated doughs of various formulations.

TABLE 10

| | Control | | Sifted-140 | | |
|---|---|---|---|---|---|
| | Recipe | Recipe | mesh | Rise 5000 | NFDM |
| Ingredients | #1 | #2 | Recipe #3 | Recipe #4 | Recipe #5 |
| Butter | 2.182 | 2.182 | 2.182 | 2.182 | 21.82 |
| Shortening | 0.545 | 0.545 | 0.545 | 0.545 | 0.545 |
| Brown Sugar | 1.364 | 1.364 | 1.364 | 1.364 | 1.364 |
| Sugar | 2.727 | 2.727 | 2.727 | 2.727 | 2.727 |
| Water | 0.109 | 0.109 | 0.109 | 0.109 | 0.109 |
| Baking Soda | 0.041 | 0.041 | 0.041 | 0.041 | 0.041 |
| Salt | 0.041 | 0.041 | 0.041 | 0.041 | 0.041 |
| Vanilla Flavor | 0.191 | 0.191 | 0.191 | 0.191 | 0.191 |
| Eggs | 0.818 | 0.818 | 0.818 | 0.818 | 0.818 |
| Non-Fat Dry Milk | 0.000 | 0.000 | 0.000 | 0.000 | 0.057 |
| Rise 5000¹ | 0.000 | 0.000 | 0.000 | 0.057 | 0.000 |
| Sorbate Flour | 0.000 | 0.230 | 0.230 | 0.230 | 0.230 |
| (Run #18) | | | | | |
| Acidified Flour | 0.000 | 1.744 | 1.744 | 1.744 | 1.744 |
| (Run #20) | | | | | |
| Flour | 4.500 | 2.527 | 2.527 | 2.470 | 2.470 |
| Chocolate Chips | 3.545 | 3.545 | 3.545 | 3.545 | 3.545 |
| Total Weight | 16.064 | 16.064 | 16.064 | 16.064 | 16.064 |
| in Ounces | | | | | |

¹Wheat protein isolate sold by MGP Ingredients of Atchison, Kansas

1. A shelf-stable food product comprising an at least partially hydrated food having a water activity of at least about 0.65 and a sufficient amount of an added acidulent to give the food an acidic pH of up to about 6, said food being non-aseptically packaged in a substantially moisture-tight package, said food product capable of ambient temperature storage for at least about 30 days without spoilage of said food within said package.

2. The food product of claim 1, said acidulent selected from the group consisting of sparingly soluble Group IIA acidic complexes, highly acidic metalated organic acids, highly acidic metalated mixtures of inorganic acids, and mixtures of the foregoing.

3. The food product of claim 2, including an additive combined with said acidulent to form an adduct, said additive selected from the group consisting of alcohols, organic acids, periodic acid and surfactants.

4. The food product of claim 1, said water activity being above about 0.7.

5. The food product of claim 1, said pH being from about 1-4.5.

6. The food product of claim 1, said food being at least partially cooked.

7. The food product of claim 6, said food being fully cooked.

8. The food product of claim 1, said acidulent being intimately mixed with said food.

9. The food product of claim 1, said acidulent being applied to the surface of said food.

10. The food product of claim 1, said food comprising at least about 35% by weight grain.

11. The food product of claim 10, said grain selected from the group consisting of wheat, oats, barley, corn, milo, rice, rye and mixtures thereof.

12. The food product of claim 10, said grain being present at a level of at least about 75% by weight.

13. The food product of claim 1, said food comprising pasta.

14. The food product of claim 1, said food comprising rice.

15. The food product of claim 1, said acidulent being present at a level of from about 0.1-7% by weight, based upon the total weight of the at least partially hydrated food taken as 100% by weight.

16. The food product of claim 15, said acidulent level being from about 0.1-2% by weight.

17. The food product of claim 1, including a quantity of a preservative.

18. The food product of claim 17, said preservative selected from the group consisting of the alkali metal sorbates.

19. The food product of claim 1, said acidulent comprising acidified calcium sulfate.

20. The food product of claim 1, said food comprising a dough.

21. The food product of claim 20, said dough comprising a cookie dough.

22. The food product of claim 1, said acidulent being encapsulated in an extruded substrate matrix.

23. The food product of claim 1, said acidulent including an additional acid selected from the group consisting of C8-C22 fatty acids, C2-C6 mono- and dicarboxylic acids, and mixtures thereof.

24. The food product of claim 1, said food being an extruded food.

25. An extruded product including a matrix encapsulating an acidulent selected from the group consisting of sparingly soluble Group IIA acidic complexes, highly acidic metalated organic acids, highly acidic metalated mixtures of inorganic acids, and mixtures of the foregoing.

26. The product of claim 25, including an additive combined with said acidulent to form an adduct, said additive selected from the group consisting of alcohols, organic acids, periodic acid and surfactants.

27. The product of claim 25, said matrix being formed of protein and/or starch.

28. The product of claim 27, said matrix formed from grain selected from the group consisting of wheat, oats, barley, corn, milo, rice, rye and mixtures thereof.

29. The product of claim 27, said matrix formed from starch.

30. The product of claim 28, said acidulent being present at a level of from about 0.1-7% by weight, based upon the total weight of said grain taken as 100% by weight.

31. The product of claim 25, including a quantity of a preservative.

32. The product of claim 31, said preservative selected from the group consisting of the alkali metal sorbates.

33. The product of claim 25, said acidulent comprising acidified calcium sulfate.

34. The product of claim 25, said acidulent including an additional acid selected from the group consisting of C8-C22 fatty acids, C2-C6 mono- and dicarboxylic acids, and mixtures thereof.

35. An extruded grain product including a matrix encapsulating a preservative.

36. The product of claim 35, said matrix being formed of protein and/or starch.

37. The product of claim 35, said matrix formed of grain selected from the group consisting of wheat, oats, barley, corn, milo, rice, rye and mixtures thereof.

38. The product of claim 35, said preservative selected from the group consisting of the alkali metal sorbates.

39. The product of claim 35, said preservative being present at a level of from about 10-20% by weight, based upon the total weight of said grain taken as 100% by weight.

40. In a dough comprising individual quantities of wheat flour and water, the improvement which comprises respective amounts of treated first and second wheat flour fractions, said first treated wheat flour fraction comprising an extruded wheat flour with an acidulent encapsulated therein, said second treated flour fraction comprising an extruded wheat flour with a preservative encapsulated therein.

41. The dough of claim 40, said acidulent being present in said dough at a level of from about 0.1-7% by weight, based upon the total weight of the dough taken as 100% by weight.

42. The dough of claim 41, said acidulent being present in said dough at a level of from about 0.1-2% by weight

43. The dough of claim 41, said preservative being present in said dough at level of from about 0.1-0.5% by weight, based upon the total weight of the preservative taken as 100% by weight.

44. The dough of claim 43, said preservative being present in said dough at a level of from about 0.1-0.2% by weight.

45. The dough of claim 40, said dough, when packaged in a substantially moisture tight package, being capable of ambient temperature storage for at least about 30 days without spoilage of said dough within said package.

46. The dough of claim 40, said dough having a water activity of at least about 0.65 and a pH of up to about 6.

47. The dough of claim 46, said water activity being above about 0.75 and said pH being from about 1-4.5.

48. A method of preparing a shelf-stable food product comprising the steps of:
providing an at least partially hydrated food having a water activity of at least about 0.65 and a sufficient amount of an added acidulent to give the food an acidic pH of up to about 6; and
non-aseptically packaging said food in a substantially moisture-tight package, said food product capable of ambient temperature storage for at least about 30 days without spoilage of said food within said package.

49. The method of claim 48, said acidulent selected from the group consisting of sparingly soluble Group IIA acidic complexes, highly acidic metalated organic acids, highly acidic metalated mixtures of inorganic acids, and mixtures of the foregoing.

50. The method of claim 49, said food including an additive combined with said acidulent to form an adduct, said additive selected from the group consisting of alcohols, organic acids, periodic acid and surfactants.

51. The method of claim 48, said water activity being above about 0.7.

52. The method of claim 48, said pH being from about 1-4.5.

53. The method of claim 48, said food being at least partially cooked.

54. The method of claim 53, said food being fully cooked.

55. The method of claim 48, said acidulent being intimately mixed with said food.

56. The method of claim 48, said acidulent being applied to the surface of said food.

57. The method of claim 48, said food comprising at least about 35% by weight grain.

58. The method of claim 57, said grain selected from the group consisting of wheat, oats, barley, corn, milo, rice, rye and mixtures thereof.

59. The method of claim 57, said grain being present at a level of at least about 75% by weight.

60. The method of claim 48, said food comprising pasta.

61. The method of claim 48, said food comprising rice.

62. The method of claim 48, said acidulent being present at a level of from about 0.1-7% by weight, based upon the total weight of the at least partially hydrated food taken as 100% by weight.

63. The method of claim 62, said level being from about 0.1-2% by weight.

64. The method of claim 48, including a quantity of a preservative.

65. The method of claim 64, said preservative selected from the group consisting of the alkali metal sorbates.

66. The method of claim 48, said acidulent comprising acidified calcium sulfate.

67. The method of claim 48, said food comprising a dough.

68. The method of claim 67, said dough comprising a cookie dough.

69. The method of claim 48, said acidulent being encapsulated in an extruded substrate matrix.

70. The method of claim 48, said acidulent including an additional acid selected from the group consisting of C8-C22 fatty acids, C2-C6 mono- and dicarboxylic acids, and mixtures thereof.

71. The method of claim 48, said food being an extruded food.
